(19) United States
(12) Patent Application Publication
(10) Pub. No.: US 2009/0170918 A1
(43) Pub. Date: Jul. 2, 2009

(54) Solid Formulation of Fungicidal Mixtures

(76) Inventor: Hilmar Wolf, Langenfeld (DE)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/066,044

(22) PCT Filed: Aug. 31, 2006
(86) PCT No.: PCT/EP2006/008512

§ 371 Date: Aug. 28, 2008

(30) Foreign Application Priority Data
Sep. 9, 2005 (DE) 102005042879.7

(51) Int. Cl. A01N 43/653; A01N 37/10; A01N 41/12; A01P 3/00

(52) U.S. Cl. 514/383; 514/539; 514/600

(57) ABSTRACT

The invention provides highly concentrated WG formulations of fungicidal mixtures, comprising
trifloxystrobin and an active ingredient selected from tebuconazole and tolylfluanid and
a dispersant from the series of Baykanol® SL, Reax® 907 and Reax® 88B,
   processes for their preparation and their use for controlling fungi.

The invention relates to solids formulations (in particular water-dispersible granules) of mixtures of trifloxystrobin (TFS) with tebuconazole or tolylfluanid (Euparen M), to a process for their preparation, and to their use for applying the active substances which they contain.

EP-A-0831698 discloses mixtures of TFS with tebuconazole, but only teaches WG formulations with an active substance content of 15% by weight. The preparation of mixtures with higher concentrations is only disclosed in the form of powders or as a suspension concentrate.

The preparation of highly concentrated WG formulations with the formulation auxiliaries mentioned in the prior art gives formulations which have undesirable properties. Thus, the low melting point of the active substance mixture results in the formation of large amounts of wet-screening residues which, when the spray mixture is later applied, lead to plugging of the nozzles. Surprisingly, it has now been found that the present, highly concentrated formulations have particularly advantageous properties. Thus, their preparation only generates very small amounts of wet-screening residues, they can be extruded readily and they have particularly high suspension stability.

The present invention accordingly provides compositions containing:
trifloxystrobin (component I)
at least one further active substance selected from tebuconazole and tolylfluanid (component II)
at least one dispersant selected from the group consisting of Baykanol® SL, Reax® 907 and Reax® 88B

In the compositions according to the invention, components I and II are present in weight ratios of from 1:30 to 12:1, preferably 1:20 to 5:1, especially preferably 1:15 to 1:1. If the composition according to the invention contains tebuconazole and tolylfluanid, these substances together are considered as component II.

Components I and II together are hereinbelow referred to as active substance.

A preferred embodiment of the invention are compositions containing
50-75%, preferably 60-75%, especially preferably 65-75% active substance
5-20%, preferably 10-20%, especially preferably 10-15% at least one dispersant selected from the group consisting of Baykanol® SL, Reax® 907 and Reax® 88B

Unless otherwise specified, percentages are understood as being percent by weight.

An embodiment of the invention which must be emphasized are those compositions in which Baykanol® SL is employed as the dispersant.

A further embodiment of the invention which must be emphasized are those compositions in which Baykanol® SL is employed as the dispersant and tebuconazole as component II.

A further embodiment of the invention which must be emphasized are those compositions in which Baykanol® SL is employed as the dispersant and tolylfluanid as component II.

It has also been found that the compositions according to the invention can be prepared by moistening a pulverulent mixture consisting of the active substances and the formulation auxiliaries, subsequently granulating it by means of low-pressure extrusion and then drying the moist granules. The relevant apparatuses for moistening, extrusion and drying are known to the skilled worker. During the preparation, care must be taken in particular that the temperatures to which the product is exposed are kept at lower than 60° C., and preferably lower than 50° C., in all process steps.

This process is also subject matter of the invention.

Finally, it has been found that the compositions according to the invention are highly suitable for the application of the agrochemical active substances present on plants and/or their environment. This method is also subject matter of the invention.

If appropriate, the compositions according to the invention contain further formulation auxiliaries, for example if appropriate substances from the groups of the emulsifiers, the anionic or nonionic surfactants, the antifoam agents, the preservatives, the antioxidants, the colorants and/or the inert fillers.

Nonionic surfactants or dispersing auxiliaries which are suitable are all substances of this type which can usually be employed in agrochemical compositions. Those which may be mentioned by preference are polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylaryl ethoxylates, which can optionally be phosphated and optionally be neutralized with bases, examples which may be mentioned by way of example being sorbitol ethoxylates, and polyoxyakyleneamine derivatives.

Anionic surfactants which are suitable are all substances of this type which can usually be employed in agrochemical compositions. Preferred are alkali metal and alkaline earth metal salts of alkylsulphonic acids or alkylarylsulphonic acids.

A further preferred group of anionic surfactants or dispersing auxiliaries are salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid.

Antifoam agents which are suitable are all substances which can usually be employed for this purpose in agrochemical compositions. Silicone oils and magnesium stearate are preferred.

Preservatives which are suitable are all substances of this type which can usually be employed for this purpose in agrochemical compositions. Examples which may be mentioned are Preventol® (Bayer AG) and Proxel®.

Antioxidants which are suitable are all substances which can usually be employed for this purpose in agrochemical compositions. Butylhydroxytoluene is preferred.

Colorants which are suitable are all substances which can usually be employed for this purpose in agrochemical compositions. Examples which may be mentioned are titanium dioxide, colour black, zinc oxide and blue pigments, and also permanent red FGR.

Inert fillers which are suitable are all substances which can usually be employed for this purpose in agrochemical compositions. Preferred are inorganic particles such as carbonates, silicates and oxides, and also organic substances such as urea/formaldehyde condensates. Examples which may be mentioned are kaolin, Futile, silicon dioxide, what is known as highly-disperse silica, silica gels, and natural and synthetic silicates, and furthermore talc.

The application rate of the formulations according to the invention can be varied within a substantial range. It depends on the respective active substances and on their content in the compositions.

Using the compositions according to the invention, the fungicidal active substance mixtures can be applied particularly advantageously to plants and/or their environment.

All plants and plant parts can be treated with the compositions according to the invention. In this context, plants are understood as meaning all plants and plant populations, such as desired and undesired wild plants or crop plants (including naturally occurring crop plants). Crop plants can be plants which can be obtained by traditional breeding and optimization methods or by biotechnological and recombinant methods or combinations of these methods, including the transgenic plants and including the plant varieties capable or not of being protected by Plant Breeders' Rights. Plant parts are understood as meaning all aerial and subterranean parts and organs of the plants, such as shoot, leaf, flower and root, examples which may be mentioned being leaves, needles, stalks, stems, flowers, fruiting bodies, fruits and seeds, and roots, tubers and rhizomes. The plant parts also include harvested material and vegetative and generative propagation material, for example cuttings, tubers, rhizomes, slips and seeds.

What may be emphasized in this context is the particularly advantageous effect of the compositions according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, paw-paw, pineapple, dates and bananas, and grapes) and vegetables (comprising leaf vegetables such as, for example, endives, corn salad, Florence fennel, various types of head lettuce and cut-and-come-again lettuce, Swiss chard, spinach and chicory, cabbages such as, for example, cauliflower, broccoli, Chinese leaves, borecole (curly kale), kohlrabi, Brussels sprouts, red cabbage, white cabbage and savoy cabbage, fruit vegetables such as, for example, aubergines, cucumbers, capsicums, table pumpkins, tomatoes, courgettes and sweetcorn, root vegetables such as, for example, celeriac, early turnips, carrots, including yellow cultivars, radish, small radish, beetroot, scorzonera and celery, legumes such as, for example, peas and beans, and bulb vegetables such as, for example, leeks and onions).

The treatment according to the invention of the plants and plant parts with the compositions according to the invention is carried out either directly or by treating their environment, habitat or storage space by the customary treatment methods, for example by dipping, spraying, vaporizing, misting, broadcasting, painting on and, in the case of propagation material, in particular seeds, furthermore by coating with one or more layers.

The compositions according to the invention have very good fungicidal properties and can be employed for controlling phytopathogenic fungi such as Plasmodiophoromycetes, Oomycetes, Chytridiomycetes, Zygomycetes, Ascomycetes, Basidiomycetes, Deuteromycetes and the like.

Examples which may be mentioned, but not by limitation, are some pathogens of fungal diseases which come under the above generic terms:

Diseases caused by pathogens causing powdery mildew such as, for example,

Blumeria species such as, for example, Blumeria graminis;
Podosphaera species such as, for example, Podosphaera leucotricha;
Sphaerotheca species such as, for example, Sphaerotheca fuliginea;
Uncinula species such as, for example, Uncinula necator;
diseases caused by pathogens of rust diseases such as, for example,
Gymnosporangium species such as, for example, Gymnosporangium sabinae
Hemileia species such as, for example, Hemileia vastatrix;
Phakopsora species such as, for example, Phakopsora pachyrhizi and Phakopsora meibomiae;
Puccinia species such as, for example, Puccinia recondita or Puccinia triticina;
Uromyces species such as, for example, Uromyces appendiculatus;
diseases caused by pathogens from the group of the Oomycctes such as, for example,
Bremia species such as, for example, Bremia lactucae;
Peronospora species such as, for example, Peronospora pisi or P. brassicae;
Phytophthora species such as, for example, Phytophthora infestans;
Plasmopara species such as, for example, Plasmopara viticola;
Pseudoperonospora species such as, for example, Pseudoperonospora humuli or Pseudoperonospora cubensis;
Pythium species such as, for example, Pythium ultimum;
leaf spot diseases and leaf wilt caused by, for example,
Alternaria species such as, for example, Alternaria solani;
Cercospora species such as, for example, Cercospora beticola;
Cladiosporium species such as, for example, Cladiosporium cucumerinum;
Cochliobolus species such as, for example, Cochliobolus sativus (conidial form: Drechslera, syn: Helminthosporium);
Colletotrichum species such as, for example, Colletotrichum lindemuthanium;
Cycloconium species such as, for example, Cycloconium oleaginum;
Diaporthe species such as, for example, Diaporthe citri;
Elsinoe species such as, for example, Elsinoe fawcettii;
Gloeosporium species such as, for example, Gloeosporium laeticolor;
Glomerella species such as, for example, Glomerella cingulata;
Guignardia species such as, for example, Guignardia bidwelli;
Leptosphaeria species such as, for example, Leptosphaeria maculans;
Magnaporthe species such as, for example, Magnaporthe grisea;
Mycosphaerella species such as, for example, Mycosphaerella graminicola;
Phaeosphaeria species such as, for example, Phaeosphaeria nodorum;
Pyrenophora species such as, for example, Pyrenophora teres;
Ramularia species such as, for example, Ramularia collo-cygni;
Rhynchosporium species such as, for example, Rhynchosporium secalis;
Septoria species such as, for example, Septoria apii;
Typhula species such as, for example, Typhula incarnata;
Venturia species such as, for example, Venturia inaequalis;
root and stalk diseases, caused by, for example,
Corticium species such as, for example, Corticium graminearum;
Fusarium species such as, for example, Fusarium oxysporum;
Gaeumannomyces species such as, for example, Gaeumannomyces graminis;
Rhizoctonia species such as, for example, Rhizoctonia solani;
Tapesia species such as, for example, Tapesia acuformis;
Thielaviopsis species such as, for example, Thielaviopsis basicola;
ear and panicle diseases (including maize cobs), caused by, for example,
Alternaria species such as, for example, Alternaria spp.;
Aspergillus species such as, for example, Aspergillus flavus;
Cladosporium species such as, for example, Cladosporium spp.;
Claviceps species such as, for example, Claviceps purpurea;
Fusarium species such as, for example, Fusarium culmorum;
Gibberella species such as, for example, Gibberella zeae;
Monographella species such as, for example, Monographella nivalis;
diseases caused by smuts such as, for example,
Sphacelotheca species such as, for example, Sphacelotheca reiliana;
Tilletia species such as, for example, Tilletia caries;
Urocystis species such as, for example, Urocystis occulta;
Ustilago species such as, for example, Ustilago nuda;
fruit rot caused by, for example,
Aspergillus species such as, for example, Aspergillus flavus;
Botrytis species such as, for example, Botrytis cinerea;
Penicillium species such as, for example, Penicillium expansum;
Sclerotinia species such as, for example, Sclerotinia sclerotiorum;
Verticilium species such as, for example, Verticilium alboatrum;
seed- and soil-borne rots and wilts, and seedling diseases, caused by, for example,
Fusarium species such as, for example, Fusarium culmorum;
Phytophthora species such as, for example, Phytophthora cactorum;
Pythium species such as, for example, Pythium ultimum;
Rhizoctonia species such as, for example, Rhizoctonia solani;
Sclerotium species such as, for example, Sclerotium rolfsii;
cankers, galls and witches' broom diseases, caused by, for example,
Nectria species such as, for example, Nectria galligena;
wilts caused by, for example,
Monilinia species such as, for example, Monilinia laxa;
deformations of leaves, flowers and fruits, caused by, for example,
Taphrina species such as, for example, Taphrina deformans;
degenerative diseases of woody species, caused by, for example,
Esca species such as, for example, Phaemoniella clamydospora;
flower and seed diseases, caused by, for example,
Botrytis species such as, for example, Botrytis cinerea;
diseases of plant tubers caused by, for example,
Rhizoctonia species such as, for example, Rhizoctonia solani;
diseases caused by bacterial pathogens such as, for example,
Xanthomonas species such as, for example, Xanthomonas campestris pv. oryzae;
Pseudomonas species such as, for example, Pseudomonas syringae pv. lachrymans;
Erwinia species such as, for example, Erwinia amylovora;
by preference, the following diseases of soya beans can be controlled:
fungal diseases on leaves, stems, pods and seeds caused by, for example,
alternaria leaf spot (Alternaria spec. atrans tenuissima), anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora cassiicola)
fungal diseases on roots and the stem base caused by, for example,
black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmopspora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

The examples which follow illustrate the subject matter of the invention without limiting it.

### EXAMPLES

In an experimental series, samples of the following general composition:

25% by weight trifloxystrobin
50% by weight tebuconazole
15% by weight dispersant
10% by weight kaolin
were extruded using a Fuji Paudal laboratory extruder type DG-1 and then subjected to comparative examinations.

### Preparation:

In the first step of the preparation, a pulverulent mixture of the above composition is prepared by mixing the starting components and subsequently subjecting the mixture to air-jet grinding using an 8 inch airjet mill. Thereafter, the powder is moistened in a Braun kitchen blender by portionwise addition of water and vigorous mixing until the powder is homogeneously moist. The amount of water whose addition allowed the best-possible extrusion in each case had been determined for each powder mixture in preliminary experiments. Depending on the dispersant used, the added water amounted to between 13 and 24% by weight, based on the amount of powder. The moistened powder is subsequently extruded by means of the laboratory extruder, and the moist granules are dried in a fluidized-bed dryer at an inlet air temperature of 60° C. and a waste air temperature of approximately 35° C., the product temperature not exceeding 40° C. The drying time varies between 2 and 12 minutes. The residual water content of the samples is between 0.3 and 1.7% and is determined via the weight loss at 70° C. using a Mettler infrared dryer moisture analyzer type LP 16.

### Test:

Wet screening: The residues were tested on a screen with a mesh size of 150 μm. The wet-screening residues are of particular importance in the preparation of WG formulations by extrusion of low-melting active substances because the extrusion process can, as the result of compaction and temperature stress, give rise to product fractions which upon the intended use in water do not redisperse into the primary particles and lead to plugging of the filters in apparatuses used in agricultural practice. As a result, spraying may have to be interrupted and the filters subjected to laborious cleaning. The wet-screening test is a laboratory test for assessing the nondispersing fractions in the formulation. In this test, the screen residue should preferably be less than 0.05% and especially preferably less than 0.02%.

A 2-litre glass beaker equipped with stirrer is charged with 1000 ml of tap water, and 50 g of the WG formulation are introduced while stirring at 500 revolutions per minute. The mixture is stirred for 150 seconds and the suspension is then poured onto a screen with a mesh size of 150 μm, the residues in the glass beaker are rinsed off with a small amount of tap water and the mixture is washed with a jet of water (rubber hose with an internal diameter of approx. 10 mm; flow rate of the tap water: approx. 4-5 l/min). During this process, the fines are rinsed through the screen. After the screen has been rinsed for several (not more than ten) minutes, it is left to drip, and, using demineralized water, the residue is transferred from the screen into a previously weighed evaporating pan and dried at 70° C. to constant weight. After cooling, the residue is weighed and the percentage of the residue based on the 50 g of formulation which have been employed is determined.

Assessment of the extrudability: The assessment of the extrudability of a mixture is based on the observations made during preparation of the sample. Factors which are taken into consideration are, for example, flowability of the moistened powder, formation of the extrudate, disintegration of the extrudate, heating and the like. Promising scale-up requires an assessment of “good” or at least “satisfactory”. “Moderate” means insufficient granulation, and “poor” means that the mixture cannot be extruded with a laboratory extruder.
Suspension stability: The suspension stability is a measure for the suspendability of the insoluble constituents of the formulation in the spray mixture. Good suspension stability ensures a homogeneous distribution of the product and thus the uniform dosage when the product is applied. The suspension stability should generally amount to >/=75%. A 1% strength suspension of the formulation is prepared in a 250-ml graduated cylinder by placing the calculated amount of granules into water, leaving the mixture to stand for 4 minutes and, after sealing the graduated cylinder with a rubber stopper, inverting the former 30 times by 180° within 1 minute. The rubber stopper is removed, and the suspension is left to stand quietly at room temperature for precisely 30 minutes. Then, the upper 9/10 of the suspension are pipetted off and the bottom tenth is transferred into a weighed evaporating pan using distilled water. The content of the pan is dried at 70° C. to constant weight, which is how the sediment is determined. The amount of suspension (suspension stability) is calculated using the formula:

Amount of suspension=(100−sediment)×1.11

Unless otherwise specified, percentages in the following tables are taken to mean percent by weight.

TABLE 1

| | | | | Wet-screening |
|---|---|---|---|---|
| Example | | Added water | Assessment of the | residue on |
| No. | Dispersant | (%) | extrudability | 150-μm screen (%) |
| 1 | Baykanol ® SL | 19 | good | 0.010 |
| 2 | Borresperse ® NA | 21 | good | 0.565 |
| 3 | Tersperse ® 2425 | 18 | good | 0.365 |
| 4 | Galoryl ® DT 530 | 14 | moderate | 0.239 |
| 5 | Kraftsperse ® DD-5 | 19 | good/satisfactory | 0.072 |
| 6 | Kraftsperse ® DD-8 | 18 | moderate | 0.069 |
| 7 | Kraftsperse ® DW-5 | 13 | satisfactory/moderate | 0.975 |
| 8 | Kraftsperse ® EDF-450 | 20 | moderate | 0.165 |
| 9 | Morwet ® D 425 | 13 | moderate | 0.741 |
| 10 | Reax ® 88 B | 21 | satisfactory | 0.040 |
| 11 | Reax ®907 | 22 | good | 0.033 |
| 12 | Ufoxane ® 3 A | 17 | good/satisfactory | 0.291 |

The results of an experimental series in which different dispersants are used are compiled in Table 1. The samples differ greatly regarding the wet-screening residues and the assessment of the extrudability. Only Examples 1, 10 and 11 meet the requirement of preferably less than 0.05% wet-screening residues. Only Examples 1 and 11 additionally have “good” extrudability. Only Example 1 has the especially preferred wet-screening residues of less than 0.02% while simultaneously exhibiting “good” extrudability.

TABLE 2

| | Example No. | | | | | | | |
|---|---|---|---|---|---|---|---|---|
| Formula | 13 | 14 | 15 | 16 | 17 | 18 | 19 | 20 |
| Trifloxystrobin [%] | 6 | 6.3 | 6.3 | 6.3 | 6.3 | 6.3 | 6.3 | 6.3 |
| Tolylfluanid [%] | 65 | 62.5 | 62.5 | 62.5 | 62.5 | 62.5 | 62.5 | 62.5 |
| Kraftsperse ® EDF-350 [%] | 15 | 15 | 15 | 15 | | | | |
| Kraftsperse ® EDF-450 [%] | | | | | | | | |
| Reax ® 907 [%] | | | | | 15 | | | |
| Baykanol ® SL [%] | | | | | | 15 | 15 | 10 |
| Geropon ® TA/72 [%] | 5 | 5 | 5 | | | | | |
| Galoryl ® MT 804 [%] | | | | 1 | 1 | 1 | 1 | 1 |
| Pergopak ® M [%] | 5 | | | 3 | 3 | | | 2 |
| Rhodorsil ® EP 6703 [%] | | 1 | 1 | 1 | 1 | | | |
| MgO [%] | | | | | | | | 1 |
| Celite ® 209 S [%] | 4 | 10.2 | | | | | | |
| Kaolin W [%] | | | 10.2 | 11.2 | 11.2 | 15.2 | | 17.2 |
| Talkum Luzenac 2 [%] | | | | | | | 15.2 | |
| Total | 100 | 100 | 100 | 100 | 100 | 100 | 100 | 100 |
| Added water during the | 30 | 25 | 25 | 20 | 20 | 15 | 12 | 25 |
| preparation [%] | | | | | | | | |

TABLE 3

| Example No. | 13 | 14 | 15 | 16 | 17 | 18 | 19 | 20 |
|---|---|---|---|---|---|---|---|---|
| Preparation | | | | | | | | |
| Suspension stability | 89 | 89 | 90 | 87 | 89 | 93 | 95 | 90 |
| [%] | | | | | | | | |
| Wet-screening | | | | | | 0.020 | 0.010 | |
| 150 μm [%] | | | | | | | | |
| 2 W/54° C. | | | | | | | | |
| Suspension stability | 53 | 27 | 38 | 34 | 87 | 91 | 88 | 72 |
| [%] | | | | | | | | |
| Wet-screening | 0.030 | 21.5 | 0 | 0.13 | 0.12 | 0.005 | 0.005 | 0 |
| 150 μm [%] | | | | | | | | |
| 4 W/40° C. | | | | | | | | |
| Suspension stability | 24.2 | 75 | 67 | 67 | 92 | 93 | 94 | 84 |
| [%] | | | | | | | | |
| Wet-screening | 0 | 0 | 0 | 0.016 | 0 | 0 | 0 | 0.023 |
| 150 μm [%] | | | | | | | | |

Table 2 compiles various formulations of trifloxystrobin in mixture with tolylfluanid. The preparation was accomplished as described further above, using a Fuji Paudal laboratory extruder type DG-1. Table 3 gives the test results of the exemplary formulations with regard to suspension stability and wet-screening residues. The tests were performed using the methods described further above. “Preparation” means that the test was performed shortly after the preparation (as a rule after not more than five days and storage at ambient temperature) of the sample, while “2 W/54° C.” and “4 W/40° C.” means that the samples were stored for 2 weeks at 54° C. or for 4 weeks at 40° C. and then tested. The test results after storage over a relatively short period at higher temperatures permit an estimate of the stability of the formulation after storage at conventional ambient temperature over a prolonged period.

In compositions containing a combination of trifloxystrobin and tolylfluanid, not only the screen residues after wet screening, but also the suspension stability present a problem. The results show that only those samples which have been prepared using the dispersants Baykanol® SL and Reax 907 (Examples 17-20) exhibit satisfactory suspension stability and wet-screening residues, especially after storage at elevated temperatures. Baykanol® SL is particularly preferable.

Kraftsperse® EDF-350 is a lignosulphonate from Westvaco Corp., Charleston Heights, S.C., USA.

Geropon® TA 72 is a sodium polycarbonate from Rhodia, Boulogne, France.

Galoryl® MT 804 is a sodium di-butylnaphthalenesulphonate from Nufarm, Melbourne, Australia.

Pergopak® M is a polymethylurea resin from Albemarle Corporation, Baton Rouge, La., USA.

Rhodorsil® EP 6703 is a polydimethylsiloxane on starch from Rhodia, Boulogne, France.

Celite® 209 S is a diatomaceous earth from Lehmann & Voss, Hamburg, Germany.

Talkum Luzenac 2 is a magnesium hydrosilicate from Luzenac Europe, Paris, France.

Kaolin W is an aluminohydrosilicate from Erbslöh Lohrheim GmbH & Co. KG, Lohrheim, Germany.

Kraftsperse® DD-5, Kraftsperse® DD-8, Kraftsperse® DW-8, Kraftsperse® EDF-450, Reax® 88B and Reax® 907 are lignosulphonates from Westvaco Corp., Charleston Heights, S.C., USA.

Borresperse® Na and Ufoxane® 3 A are lignosulphonates from Borregaard, Sarpsborg, Norway.

Morwet® D 425 is a naphthalenesulphonic acid/formaldehyde condensate, sodium salt, from Akzo Nobel, Stenungsund, Sweden.

Galoryl® DT 530 is a naphthalenesulphonic acid/formaldehyde condensate, sodium salt, from Nufarm, Melbourne, Australia.

Tersperse® is a naphthalenesulphonic acid/formaldehyde condensate, sodium salt, from Huntsman, The Woodlands, Tex., USA.

Baykanol® SL is an alkylarylsulphonate from Lanxess, Leverkusen, Germany.

1. A composition comprising
trifloxystrobin,
at least one active substance selected from tebuconazole and tolylfluanid, and
at least one dispersant; wherein a suspension of 50 grams of said composition in 1000 ml of water exhibits less than 0.05% residue when subjected to wet screening through a screen having a mesh size of 150 μm.

2. A composition according to claim 1, further comprising at least one wetter and inert filler.

3. A composition according to claim 1 further comprising one or more formulation auxiliaries selected from the group consisting of emulsifiers, surfactants, antifoam agents, preservatives, antioxidants, colorants, and inert fillers.

4. A composition according to claim 1 wherein said dispersant is a condensate of sulfonated ditolyl ether and formaldehyde.

5. A composition according to claim 1 comprising at least one further fungicidal active substance.

6. A process for the preparation of a wettable granule formulation comprising extruding said composition of claim 1 under low-pressure and at a temperature below 60° C.

7. (canceled)

8. A composition according to claim 1 comprising extenders and/or surface-active agents.

9. (canceled)

10. A composition according to claim 1, wherein said dispersant is a lignosulfonate sodium salt having CAS No. 68512-35-6.

11. A composition according to claim 1, wherein said dispersant is a lignosulfonate sodium salt having CAS No. 68512-34-5.

12. A method of controlling fungi, comprising contacting said fungi or their habitat with a composition according to claim 1.

13. A composition comprising
trifloxystrobin,
at least one active substance selected from tebuconazole and tolylfluanid, and
at least one dispersant, wherein a 1% suspension of said composition in water exhibits a suspension stability of greater than or equal to 75% after standing for 30 minutes.
